(19) United States
(12) Patent Application Publication
(10) Pub. No.: US 2025/0392067 A1
(43) Pub. Date: Dec. 25, 2025

(54) ELECTRICAL CONNECTOR WITH IMPROVED TERMINALS

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: FANG-JWU LIAO, New Taipei (TW)

(21) Appl. No.: 19/245,847

(22) Filed: Jun. 23, 2025

(30) Foreign Application Priority Data
Jun. 25, 2024 (CN) 202421462172.6

(51) Int. Cl. H01R 13/24

(52) U.S. Cl. CPC H01R 13/245

(57) ABSTRACT

An electrical connector includes an insulating housing and at least one terminal component retained in the insulating housing, wherein the at least one terminal component includes plural terminals arranged side by side in a transverse direction and a bridge portion connecting every two adjacent terminals, each terminal includes a transverse beam, plural upper elastic arms extending from the transverse beam upwardly, and two strip connecting portions at two ends of the transverse beam respectively, each upper elastic arm includes an upper slating portion and an upper contacting portion, the bridge portion connects two adjacent strip connecting portions of two adjacent terminals to form a latching groove therebetween, and the insulating housing has plural latching blocks received and latched in corresponding latching grooves.

### BACKGROUND OF THE INVENTION

### FIELD OF THE INVENTION

The present invention relates to an electrical connector with improved terminals.

### DESCRIPTION OF RELATED ARTS

U.S. Patent No. 11,050,173 discloses an electrical connector which comprises an insulating housing and plural unified contacts retained in the insulating housing. Each unified contact has three sets of independent spring arms (six spring arms) but only with two barbs for fixing at two side edges thereof.

With a rapid development of the electrical connector for a high frequency transmitting or large current transmitting, more spring arms with contacting portions of one unified contact are needed. However , the two barbs of one unified contact make the unified contact with six spring arms difficult to be fixed in the insulating housing, let alone for a unified contact with more than six spring arms.

Therefore, it is necessary to provide an electrical connector with improved terminals.

### SUMMARY OF THE INVENTION

The object of the present invention is to provide an electrical connector with improved terminals.

To achieve the above object, an electrical connector comprises: an insulating housing; and at least one terminal component retained in the insulating housing; wherein the at least one terminal component comprises plural terminals arranged side by side in a transverse direction and a bridge portion connecting every two adjacent terminals, each terminal comprises a transverse beam, plural upper elastic arms extending from the transverse beam upwardly, and two strip connecting portions at two ends of the transverse beam respectively, each upper elastic arm comprises an upper slating portion and an upper contacting portion, the bridge portion connects two adjacent strip connecting portions of two adjacent terminals to form a latching groove therebetween, and the insulating housing has plural latching blocks received and latched in corresponding latching grooves.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector of a first embodiment of the present invention;

FIG. 2 is a part of the electrical connector in FIG. 1;

FIG. 3 is an exploded perspective view of the electrical connector in FIG. 2;

FIG. 4 is a cross-sectional view of the electrical connector in FIG. 2;

FIG. 5 is a front view of a terminal of a terminal component in FIG. 2;

FIG. 6 is an exploded perspective view of the electrical connector of a second embodiment of the present invention;

FIG. 7 is a perspective view of the electrical connector of a third embodiment of the present invention;

FIG. 8 is an exploded perspective view of the electrical connector in FIG. 7;

FIG. 9 is a cross-sectional view of the electrical connector in FIG. 7; and

FIG. 10 is a front view of the terminal in FIG. 8.

### DETAILED DESCRIPTION OF THE PREFERRED EMBODIMENT

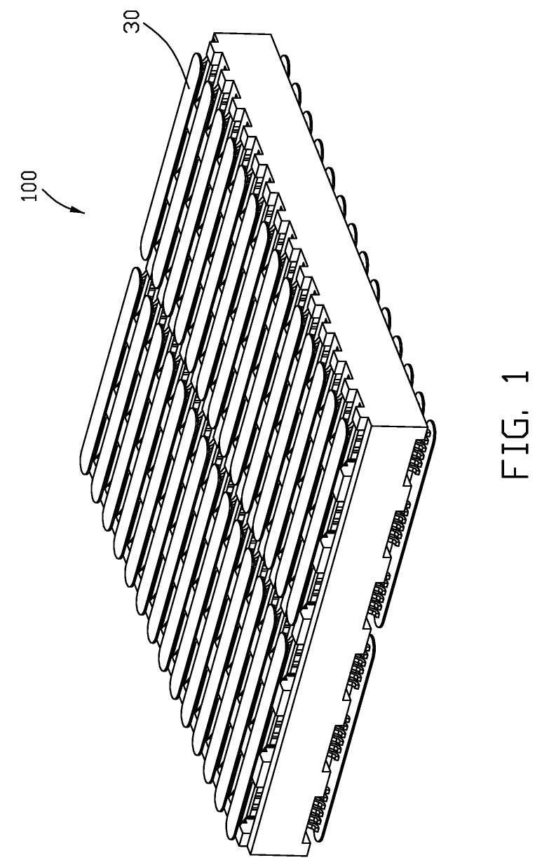

Referring to FIG. 1, an electrical connector 100 of a first embodiment of the present invention is illustrated. The electrical connector 100 is used for transmitting signals, and includes an insulating housing 10 and plural terminal components 20 retained in the insulating housing 10. Each terminal component 20 consists of multiple terminals 21 connected in series. Each terminal 21 comprises plural contacting portions.

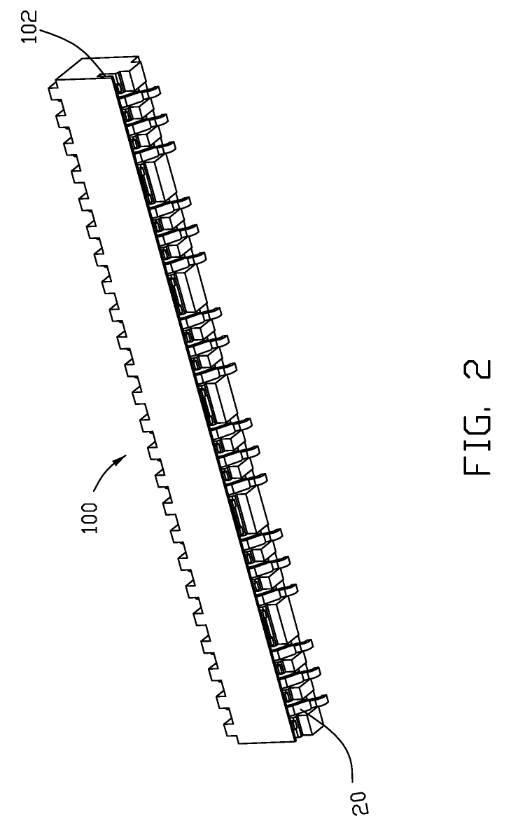

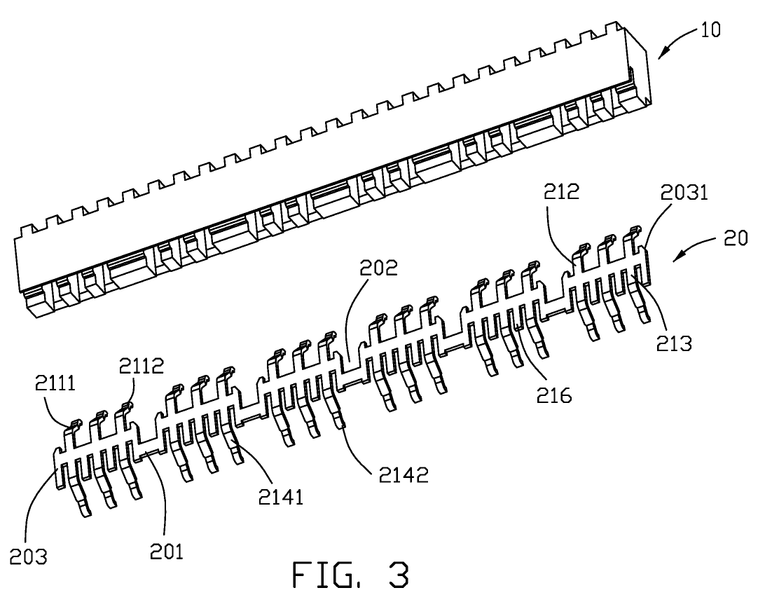

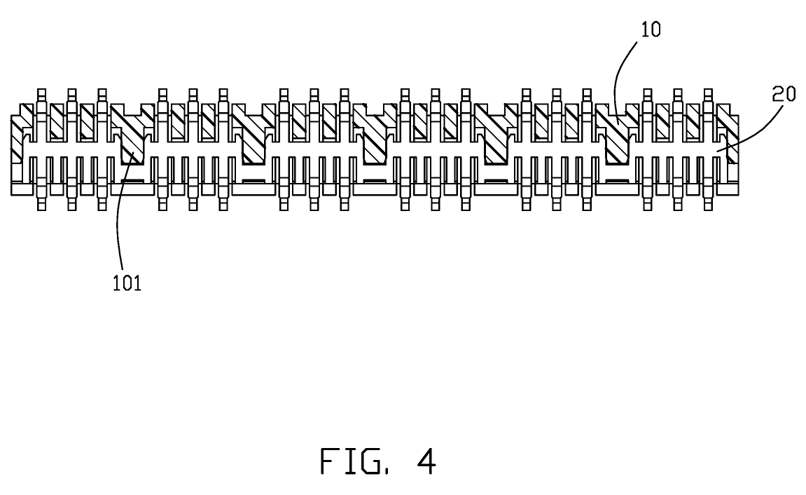

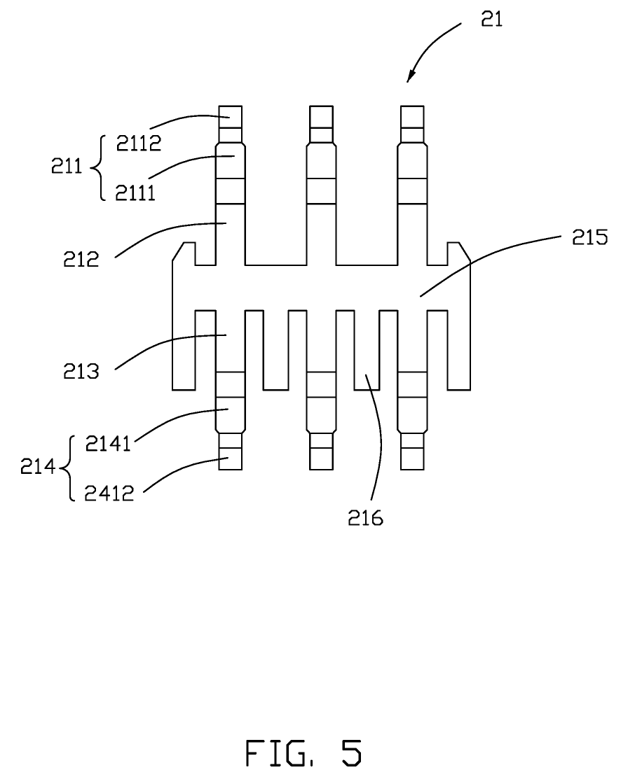

Referring to FIGS. 2-5, only one terminal component 20 and the corresponding insulating housing 10 for accommodating the one terminal component 20 is shown. The terminal component 20 comprises plural terminals 21 arranged side by side in a transverse direction and a bridge portion 201 connecting two adjacent terminals 21. Each terminal 21 comprises a transverse beam 215, plural upper elastic arms 211 and two strip connecting portions 203 at two ends of the beam 215. Each upper elastic arm 211 comprises an upper slanting portion 2111 and an upper contacting portion 2112, the bridge portion 201 connects the strip connecting portions 203 of two adjacent terminals 21 and form a latching groove 202, the insulating housing 10 has plural latching portions 101 that are latched in the corresponding latching grooves 202. Preferably, the insulating housing 10 has a receiving groove 102 opening downward for accommodating the terminal component 20, and the latching portions 101 are located in the receiving grooves 102. The latching grooves 202 open upward. The latching portions 101 are tightly held in the latching grooves 202, and thus, the terminal component 20 are stably fixed in the insulating housing 10. In addition, the two strip connecting portions 203 at two opposite side edges of the terminal component 20 tightly abuts against an inside wall of the receiving groove 102 for further fix of the terminal component 20 into the receiving groove 102.

Referring to FIGS. 2-4, the terminal component 20 is formed by an integral metal plate and has six terminals 21. Each terminal 21 has at least three upper elastic arms 211 and lower elastic arms 214, and the number of the lower elastic arms 214 is the same as a number of the upper elastic arms 211. Each lower elastic arm 214 has a lower slanting portion 2141 and a lower contacting portion 2142. Each terminal 21 has a set of upper vertical portions 212 extending from the transverse beam 215 upwardly and a set of lower vertical portions 213 extending from the transverse beam 215 downwardly. The upper elastic arms 211 extend from corresponding upper vertical portions 212 and the lower elastic arms 214 extend from corresponding lower vertical portions 213 respectively, the upper elastic arms and the lower elastic arms are in mirror image symmetry. Each terminal 21 comprises a spacer rib 216 that extends downward from the transverse beam 215 and is disposed between two adjacent lower vertical portions 213 to increase the terminal power load thereof. The transverse beams 215, the strip connecting portions 203, the bridge portions 201 and the spacer ribs 216 are in a same vertical plane. The bridge portion 201 and the transverse beam 215 are not in the same height, and the bridge portion 201 is lower than the transverse beam 215.

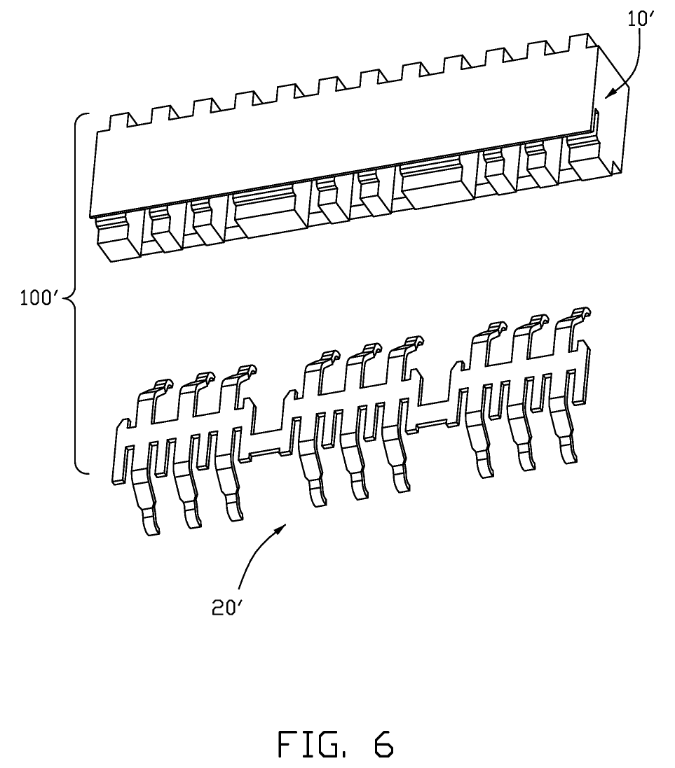

Referring to FIG. 6, an electrical connector 100’ of a second embodiment of the present invention is illustrated and the electrical connector 100’ is substantially the same as the electrical connector 100 in the first embodiment. Similarities of the electrical connector 100’ and the electrical connector 100 are not repeated. The difference between a terminal component 20’ of this embodiment and the terminal component 20 resides in that the terminal component 20’ has only three terminals 21, and the insulating housing is correspondingly short.

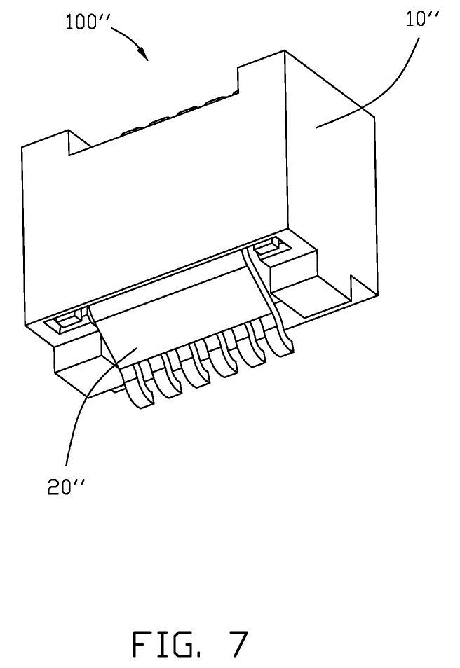

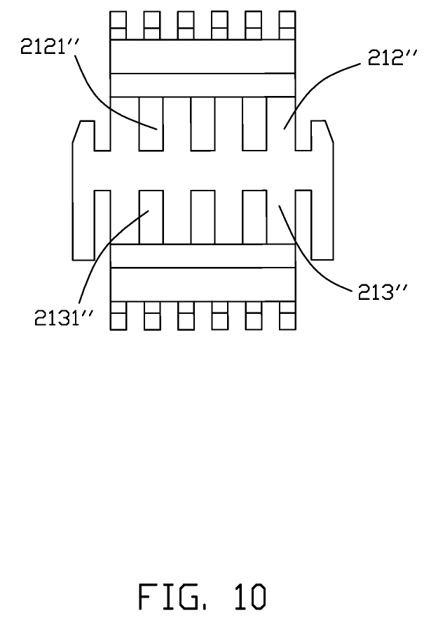

Referring to FIGS. 7-10, an electrical connector 100’’ of a third embodiment of the present invention is illustrated. The electrical connector 100’’comprises an insulating housing 10’’and a terminal component 20’’. In this embodiment, the terminal component 20’’ comprises only one terminal 21’’, and the terminal 21’’ comprises a transverse beam 215, plural upper vertical portions 212’’, plural lower vertical portions 213’’, strip connecting portions 203’’, an upper elastic arm 211’’ and a lower elastic arm 214’’. Similar to the first embodiment and the second embodiment, the strip connecting portions 203’’ can not only connect with a strip for a convenient assembling of the terminal component into the insulating housing, but also act as a latching bar for fixing the the terminal component into the insulating housing. The upper elastic arm’’ 211 comprises an integral upper slanting portion 2111’’ and plural upper contacting portions 2112’’, the lower elastic arm comprises an integral lower slanting portion 2141’’ and plural lower contacting portions 2142’’. The difference between the terminal 21’’ and the terminal 21 resides in that both the upper slanting portion 2111’’ and the lower slanting portion 2141’’ are an integral plate and connect with plural contacting portions while the upper slanting portion 2111 and the lower slanting portion 2141 are independent and connect with only one corresponding contacting portion, similarly, the upper slanting portion 2111’’and the lower slanting portion 2141’’connect with plural vertical portions while the upper slanting portion 2111 and the lower slanting portion 2141 connect with only one corresponding vertical portion respectively. In addition, a number of the upper contacting portions 2112’’ of one terminal 21’’ is more than the number of the upper vertical portions 212’’ while a number of the upper contacting portions 2112 of one terminal 21 equals to the number of the upper vertical portions 212, 212’. Similar to the upper elastic arms, a number of the lower contacting portions 2142’’ is more than the number of the lower vertical portions 213’’ of one terminal 21’’ while a number of the lower contacting portions 2142 equals to the number of the lower vertical portions 213 of one terminal 21. The more upper contacting portions 2112 and the lower contacting portions 2142’’ can effectively reduce impedance during power transmission when contact with a conductive member 30. The strip connecting portions 203’’ extend vertically from two ends of the transverse beam 215’’ respectively, and the terminal 21’’ can be fixed in the insulating housing 10’’ by the strip connecting portions 203’’. Similar to the terminal component 20’, in other embodiments, the terminal component 20’’ may comprises plural terminals 21 connected with each other by connecting the strip connecting portions 203’’ of two adjacent terminals 21’’to adjust the impedance and improve a performance of the electrical connector 100'' for transmitting large current or high frequency signals.

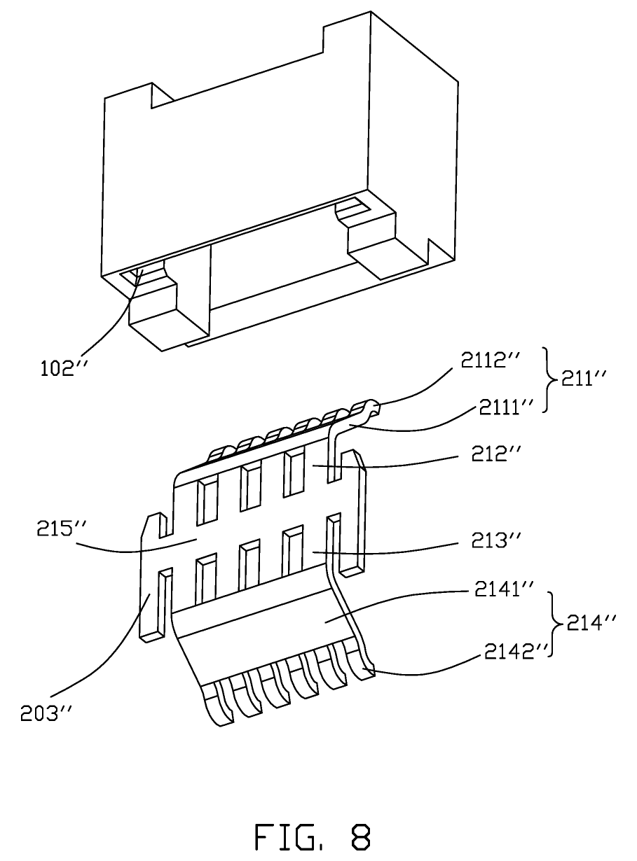

Referring to FIGS. 8-10, a number of the upper contacting portions 2112’’ and the lower contacting portions 2142’’ is not less than 4, preferably, the number of the upper contacting portions 2112’’ and the lower contacting portions 2142’’ is 6. As the upper slanting portion 2111’’ and the lower slanting portion 2141’’ are integral plates, normal pressure applied to the terminals 21 is often not sufficient to deform the terminals into place. An upper slot 2121’’ is provided between two adjacent upper vertical portions 212 and a lower slot 2131’’ is provided between two adjacent lower vertical portions 213’’ to increase the elasticity of the terminal 21’’. Preferably, the terminal 21’’ has three upper slots 2121’’ and three lower slots 2131’’, and the upper slots 2121’’ and the lower slots 2131’’ are in mirror image symmetry.

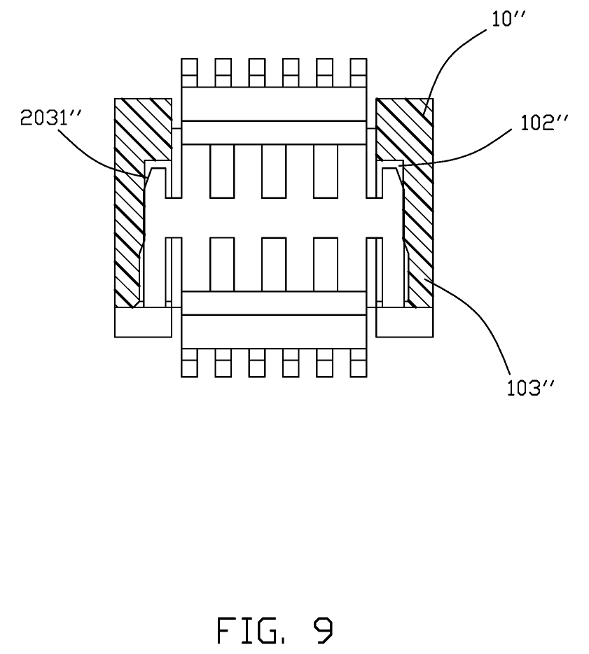

Referring to FIGS. 8-9, the insulating housing 10’’ has a receiving groove 102’’ which penetrates a lower face thereof and defines a downward opening. A width of a lower portion of the groove 102’’ is larger than a width of an upper portion of the groove 102’’. Chamfers are provided at two ends of the opening and between the wider lower portion of the groove 102’’and the narrower upper portion of the groove 102’’. The terminal 21’’ can be assembled into the groove 102’’ from the opening of the groove 102’’ by the chamfers of the groove 102’’ and chamfers of the strip connecting portions 203’’.

The above-mentioned embodiments are only preferred embodiments of the present invention, and should not limit the scope of the present invention, any simple equivalent changes and modifications made according to the claims of the present invention and the contents of the description should still belong to the present invention.

What is claimed is:

1. An electrical connector comprising:an insulating housing; andat least one terminal component retained in the insulating housing;
wherein the at least one terminal component comprises plural terminals arranged side by side in a transverse direction and a bridge portion connecting every two adjacent terminals, each terminal comprises a transverse beam, plural upper elastic arms extending from the transverse beam upwardly, and two strip connecting portions at two ends of the transverse beam respectively, each upper elastic arm comprises an upper slating portion and an upper contacting portion, the bridge portion connects two adjacent strip connecting portions of two adjacent terminals to form a latching groove therebetween, and the insulating housing has plural latching blocks received and latched in corresponding latching grooves.

2. The electrical connector as claimed in claim 1, wherein the at least one terminal component comprises at least three terminals and each terminal has at least three upper elastic arms.

3. The electrical connector as claimed in claim 2, wherein the at least one terminal component is stamped from an integral mental plate.

4. The electrical connector as claimed in claim 1, wherein each terminal comprises plural upper vertical portions extend from the transverse beam upwardly and vertically, and the upper elastic arms connect with the upper vertical portions one by one correspondingly.

5. The electrical connector as claimed in claim 4, wherein each terminal comprises plural lower elastic arms and lower vertical portions, the lower vertical portions extend from the transverse beam downwardly and vertically, and the lower elastic arms connect with the lower vertical portions one by one correspondingly.

6. The electrical connector as claimed in claim 5, wherein the latching groove opens upward, and a chamfer is provided at an upper end of the strip connecting portion for the latching blocks to enter the latching grooves.

7. The electrical connector as claimed in claim 5, wherein each terminal comprises plural spacer ribs, and each spacer rib is between two adjacent lower vertical portions.

8. The electrical connector as claimed in claim 5, wherein the transverse beam, the strip connecting portions, the bridge portions, and the spacer ribs are in a same vertical plane, and the bridge portion is leveled lower than the bridge portion.

9. An electrical connector, comprising: an insulating housing; and at least one terminal component retained in the insulating housing;
wherein the at least one terminal component comprises plural terminals connected in series along a transverse direction and a respective bridge portion connected between every two adjacent terminals, each terminal comprises a transverse beam, two strip connecting portions at two ends of the transverse beam, plural upper vertical portions extending from the transverse beam upwardly and vertically, plural lower vertical portions extending from the transverse beam downwardly and vertically, plural upper elastic arms extending obliquely and upwardly from Page 2 of 4 corresponding upper vertical portions, and plural lower elastic arms extending obliquely and downwardly from corresponding lower vertical portions, and the bridge portions connect every two adjacent strip connecting portions.

10. The electrical connector as claimed in claim 9, wherein a latching groove with an opening is formed by the bridge portion and two corresponding strip connecting portions, and the insulating housing has plural latching blocks received and latched in corresponding latching grooves.

11. The electrical connector as claimed in claim 9, wherein the upper vertical portions, the lower vertical portions, the transverse beams, and the strip connecting portions are in a same plane.

12. The electrical connector as claimed in claim 9, wherein both a number of the upper elastic arms and a number of the lower elastic arms are three.

13. The electrical connector as claimed in claim 9, wherein a chamfer is provided at an upper end of each strip connecting portion, the bridge portion connects the lower ends of the strip connecting portions, and the transverse beam is between the chamfer and the bridge portion in an up-to-down direction.

14. An electrical connector comprising:
an insulating housing; and
at least one independent terminal being fixed in the insulating housing and comprising:
a transverse beam, two strip connecting portions extending vertically from two ends of the transverse beam, plural upper vertical portions extending from the transverse beam upwardly, an integral upper slanting portion connecting with all upper ends of the upper vertical portions, and plural upper contacting portions extending from the integral upper slanting portion; and
plural lower vertical portions extending from the transverse beam downwardly, an integral lower slanting portion connecting with all lower ends of the lower vertical portions, and plural lower contacting portions extending from the integral lower slanting portion.

15. The electrical connector as claimed in claim 14, wherein the upper vertical portions, the upper slanting portion, and the upper contacting portions are a mirror image of the lower vertical portions, the lower slanting portion, and the lower contacting portions, respectively.

16. The electrical connector as claimed in claim 14, wherein the number of the upper contacting portions is greater than the number of the upper vertical portions and the number of the lower contacting portions is greater than the number of the lower vertical portions.
